(19) United States
(12) Patent Application Publication
(10) Pub. No.: US 2022/0255349 A1
(43) Pub. Date: Aug. 11, 2022

(54) INDUCTIVELY POWERED DOOR LOCKS AND RETROFIT KITS FOR BATTERY POWERED DOOR LOCKS

(71) Applicant: 1 VALET CORP., Gatineau (CA)

(72) Inventor: Jean-Pierre POULIN, Gatineau (CA)

(21) Appl. No.: 17/433,396

(22) PCT Filed: Feb. 25, 2020
(86) PCT No.: PCT/CA2020/050236

§ 371 Date: Aug. 24, 2021

Related U.S. Application Data
(60) Provisional application No. 62/809,881, filed on Feb. 25, 2019.

(51) Int. Cl. H02J 50/10; H02J 7/00; H02J 7/02

(52) U.S. Cl. CPC H02J 50/10; H02J 7/0068; H02J 2207/20; H02J 7/0013; H02J 7/02

(57) ABSTRACT

An inductively powered door lock comprising an electric door lock equipped with a power receiving module operatively associated with one or more rechargeable batteries within the door lock and transmitting module with the door frame is provided. A kit for converting a powered door lock into an inductively powered door lock is also provided.

### FIELD OF THE INVENTION

This invention pertains generally to powered door locks and, in particular, to inductively powered door locks and retrofit kits for battery powered door locks.

### BACKGROUND OF THE INVENTION

Smart or electric door locks are increasingly considered a necessity in today's smart home. Smart locks increase accessibility, allow for convenient authentication, and eliminate the concept of lost or misplaced keys. These locks are also programmed to allow certain people have the access to your home and can be operated remotely from anywhere. The market for smart locks is growing at a steady pace every year.

Conventional smart electric door locks are generally powered by disposable 4 AA Ni—Mh batteries in series each delivering 1.5 volts and rated for 2500 mAh. These batteries are not rechargeable and need replacing every 3-6 months depending on usage. Replacing the batteries is tedious, expensive and results in extensive battery wastage. Batteries are toxic to the environment and often end up in landfills. Although rechargeable AA batteries could be used instead of disposable 4 AA Ni—Mh batteries, this does not eliminate the need to replace the batteries while the rechargeable batteries recharge. Replacement of batteries in the door locks whether conventional or rechargeable is inconvenient.

Recent developments in inductive charging have been applied to electric door locks including those described in U.S. Pat. Nos. 9,876,386 and 9,673,868. These systems however are not amendable to retrofit of existing electric door locks. Accordingly, there exists a need for a system that provides for the retrofit of existing electric door locks.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide inductively powered door locks and retrofit kits for battery powered door locks. In accordance with an aspect of the present invention, there is provided an inductively powered door lock comprising an electric door lock equipped with a power receiving module operatively associated with one or more rechargeable batteries within the door lock and transmitting module with the door frame.

In accordance with another aspect of the invention there is provided a kit for converting a powered door lock to an inductively powered door lock, the kit comprising a doorframe module, door module, battery pack and installation instructions.

### BRIEF DESCRIPTION OF THE DRAWINGS

These and other features of the invention will become more apparent in the following detailed description in which reference is made to the appended drawings.

FIG. 1 illustrates a typical smart door lock.

FIG. 2 illustrates interaction between the components of an installed retrofit kit of one embodiment of the invention.

FIG. 3 illustrates an alternative embodiment of the installed retrofit kit.

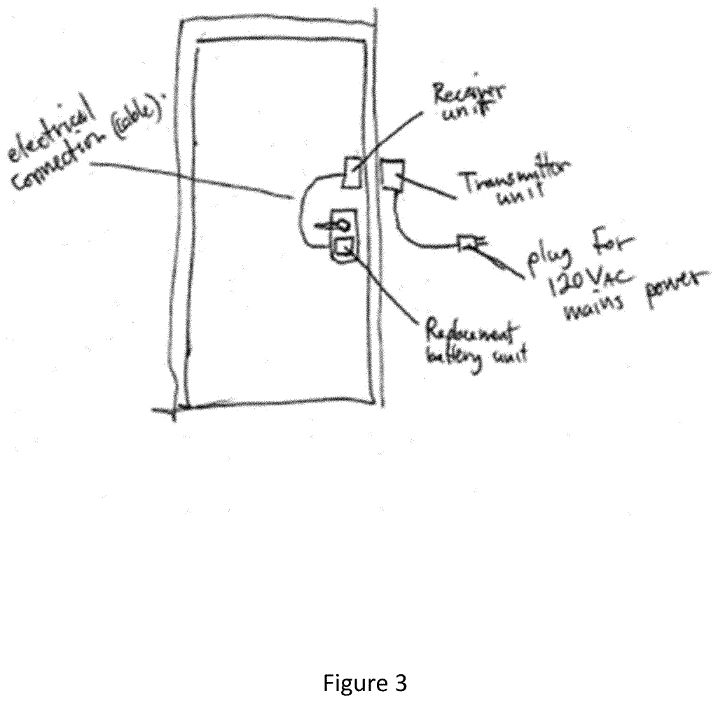

FIG. 4 illustrates one embodiment of the door power transmitter installed on the doorframe.

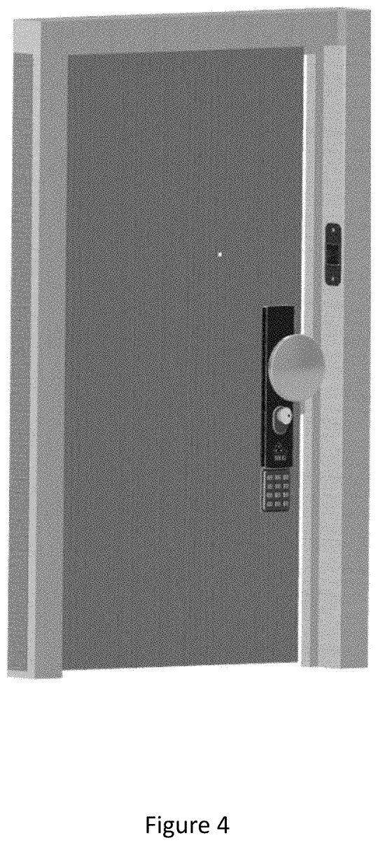

FIG. 5 illustrates one embodiment of the door power receiver installed on the door.

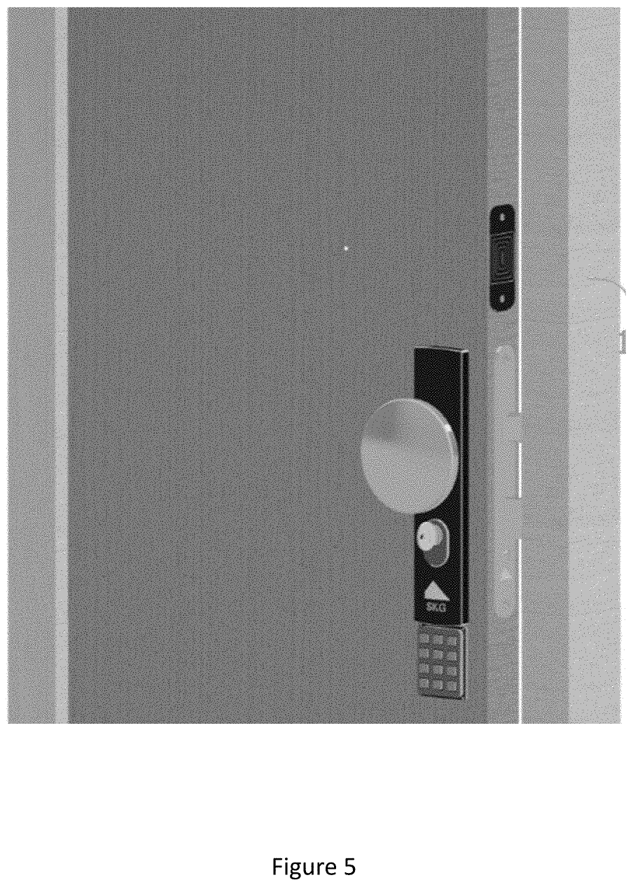

FIG. 6 shows installed battery pack in comparison to the four AA batteries it replaces.

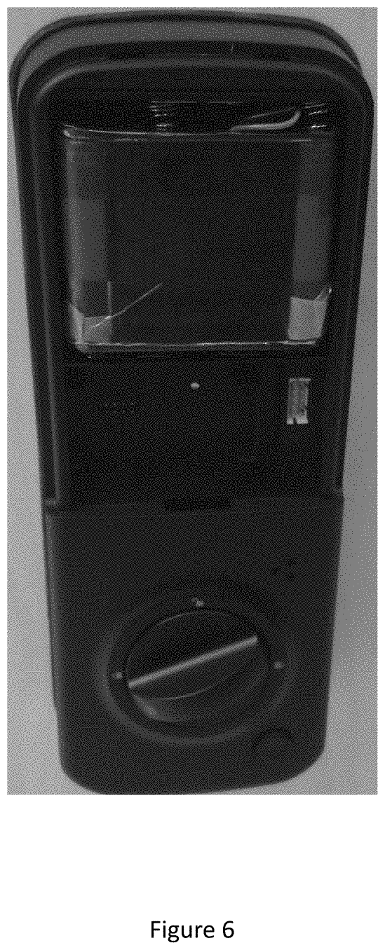

FIG. 7 illustrates one embodiment of the battery pack.

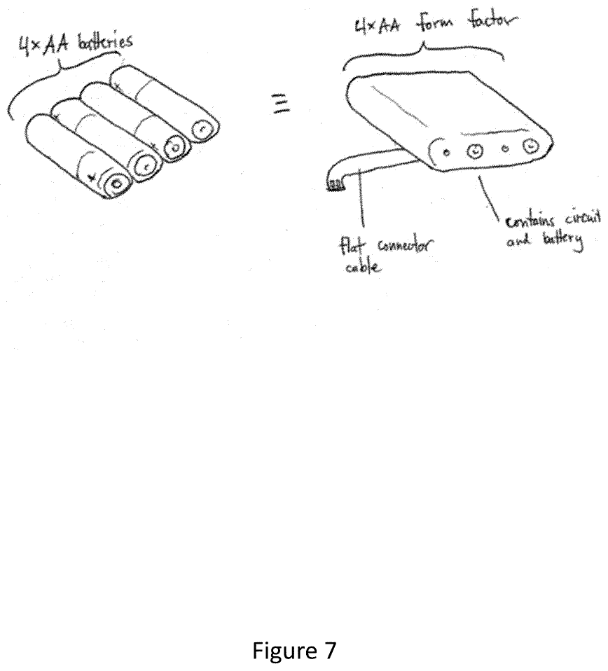

FIG. 8 shows transmitter front, back, and sideways view with printed circuit board (PCB).

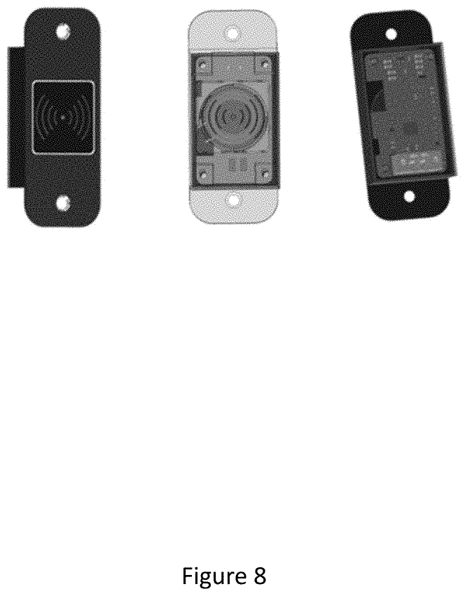

FIG. 9 shows receiver and PCB back view.

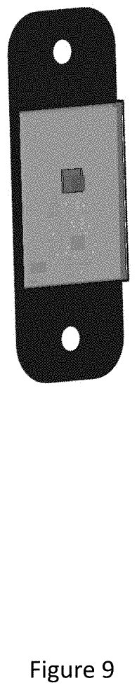

FIG. 10 shows receiver and PCB front view.

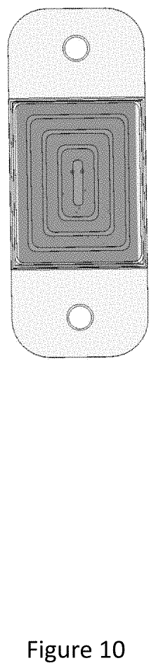

FIG. 11 details one embodiment of the battery pack (A) detailing the body (B) and top cover (C) and bottom cover (D). Also shown are variations of the contacts (E).

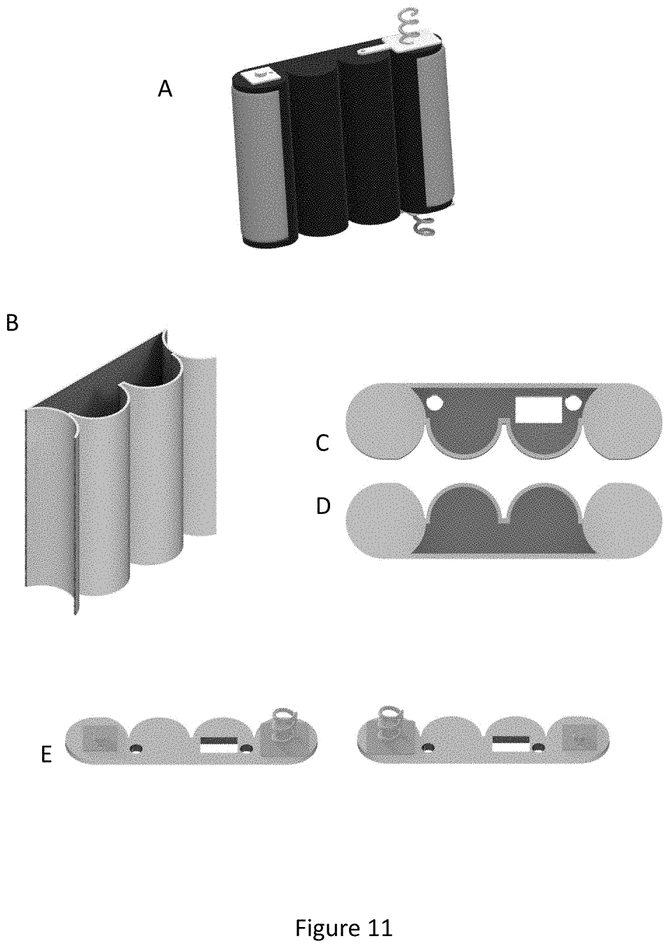

### DETAILED DESCRIPTION OF THE INVENTION

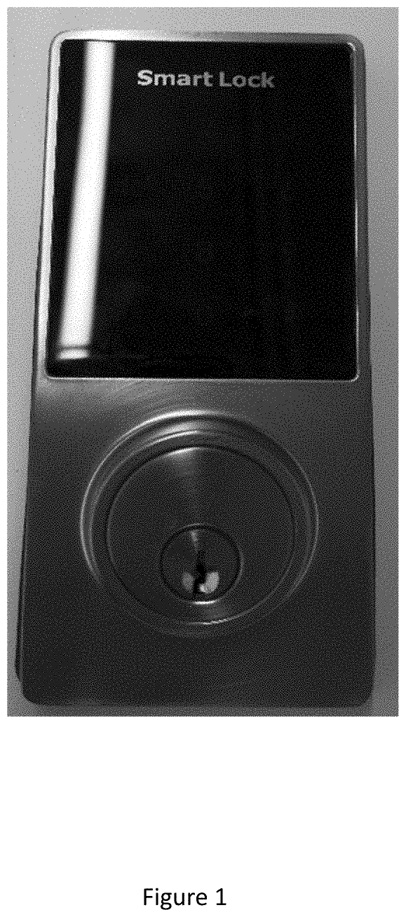

Referring to FIG. 1, a variety of smart locks are available on the market. Smart locks are a convenient way to provide keyless entry and depending on model provide a variety of other features. These features include entry tracking, real time alerts, limited access digital keys, proximity unlock, voice unlock and remote lock and unlock. Smart locks may also be integrated into smart home ecosystems. Most smart locks are powered by multiple AA alkaline batteries or a rechargeable cell. Depending on lock features, battery life for smart locks is generally between three months to one year. This invention eliminates the need to replace batteries in smart locks including commercially available smart locks by replacing the existing battery pack with an inductively charged battery pack. In particular, the invention provides inductively powered door locks and kits for converting conventional battery powered door locks into inductively powered door locks.

In some embodiments, the locks and kits of the invention are configured to allow for installation with minimal modifications to the existing door assembly and/or frame. In certain embodiments, the transmitter and receiver of the inductive charging unit are designed to be installed in such a manner that the fire rating of the door is maintained.

Kits for converting conventional battery powered door locks into inductively powered door locks are designed to be compatible with more than one conventional battery powered door lock and preferably to the majority of locks on the market. The kits are configured to require minimal modification to the smart lock. The kits include a door frame module including power transmitter for installation on the door frame and configured for connection to a power supply, a door module including a power receiver for installation on the door and a battery pack configured for installation into the smart lock and electrical connection to the power receiver. Optionally, kits include components necessary for installation and instructions for installation.

In some embodiments, the kit includes a 120 to 5-volt buck-boost transformer for mounting near the door to supply regulated 5 volts to the power transmitter in the doorframe module.

In some embodiments, the kits include a commercially available smart lock.

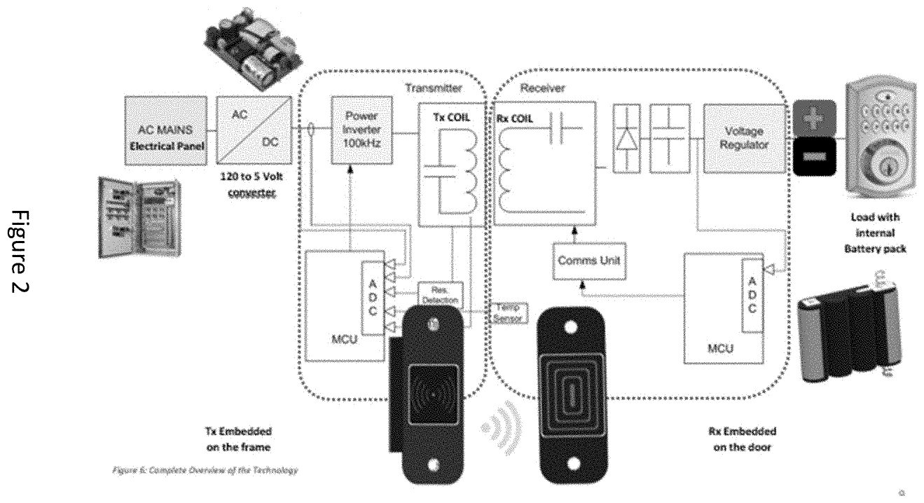

Referring to FIG. 2, the invention comprises a door frame module, a door module and rechargeable battery pack. When installed, a wireless charging link between the doorframe module and door module is established. In some embodiments, the link is a unidirectional inductively coupled link generated from the transmitter coil in the door frame module to the receiver coil in the door module. The doorframe module and door module are configured to optimize the distance between the transmitter coil and receiver coil thereby minimizing loss of power when the door is closed. In some embodiments, the distance between the coil is between about 8 mm to about 12 mm.

The inductively powered door locks and retrofit kits are compatible with the Qi and/or the PMA standards. Accordingly, the door frame and door modules are configured in accordance with the standard utilized.

Doorframe Module:

The doorframe module is operatively connected to the electricity supply/power source. The doorframe module may be wired into electricity supply/power source or be wired for plug in or connection by other means known in the art. Optionally, a 120 to 5-volt buck-boost transformer is provided to supply regulated 5 volts to the power transmitter in the doorframe module. In some embodiments, the 120 to 5-volt buck-boost transformer is integrated into the doorframe module. In alternative embodiments, the 120 to 5-volt buck-boost transformer is provided as a separate component.

The doorframe module includes the base station/power transmitter contained within an enclosure. The base station/power transmitter is configured to provide the inductive power to the door module and includes a transmitter, a transmitting coil and surface for interfacing with the door module. The surface for interfacing with the door module is optionally configured to be within the door jamb or wrap or partially wrap around the door jamb. In some embodiments, the surface is configured to sit within a recess in the door jamb including recesses for the door latches and/or deadbolts. In some embodiments, the surface for interfacing with the door module is configured to replace the striking plate.

Optionally, the base station/power transmitter includes a 5 v Qi wireless transmitter, optionally a NXQ1TXH5 5 V Qi wireless transmitter operatively connected Qi-compliant type A5, A11, A12, or A16 transmitter coil.

In some embodiments, the enclosure of the transmitter is configured such that there is as maximum thickness of 1 mm between the coil and the air gap, as well as a ferrite sheet between the printed circuit board and the coil itself as to not change its induction or induce rogue eddy currents. In order to dissipate the heat that the transmitter produces a heat dissipating material, for example a silicon rubber such as Sarcon® is optionally applied on the ground plane or the chip itself as a heat sink.

Door Module:

The door module includes the receiver unit with the secondary coil. The receiver unit is operatively connected to a replacement battery unit via an electrical connection or cable that are known in the art. The replacement battery unit includes a battery pack configured to replace the batteries within the powered door lock. The battery pack includes the batteries and circuit and connector, optionally a flat connector, cable for connection to the receiver unit. In some embodiments, the electrical connection between the receiver unit and the replacement battery unit is two wires. In some embodiments, the wires are in the door and run into the lock internally and to supply current to the Battery Pack.

In some embodiments, the door module includes a BQ51013B—VQFN package (BQ51013BRHLR) receiver chip operatively associated with a receiver coil. In some embodiments, the receiver coil is a coil manufactured by Nucurrent™ with a digikey part number: WM15000-ND.

Battery Pack

The battery pack is configured to replace the batteries of the smart lock and is shaped to mirror the shape of the batteries it replaces.

In certain embodiments, the battery pack is configured to replace 4 AA batteries totaling 6 volts and includes a battery holder having a body, top and bottom covers with contacts, circuit board and lithium ion batteries. Optionally, the top or bottom cover is attached or integrated with the body. In some embodiments, the battery pack includes 2 lithium ion batteries connected in parallel. In some embodiments, the batteries are charged using the MCP7371 chip.

In certain embodiments, the body of the battery holder is configured to fit into the battery compartment of a smart lock and has a shape that mimics the four AA batteries that the lock normally uses. In some embodiments, it is configured to fit two 14430 lithium-Ion batteries. Optionally, the body has open sides so that two 14430 batteries can be used while still fitting into the constraints of the lock. In some embodiments, the top and bottom covers for the battery pack are designed to fit into the body without any external pressure. Both parts will be covered with copper foil on one side, this will allow that batteries to be connected in parallel, increasing the mAh giving that battery a longer lasting life. Optionally, the top cover differs from the bottom cover, three holes are cut out for the connection to the receiver. Plus, two holes for positive and negative contacts that will go to power the lock.

The battery pack can include different configurations of contact pads depending on the lock it is to be retrofitted into.

Optionally, the battery pack has two contact pads connected to the top cover to allow for variations in smart lock design. In some embodiments, the male contact is on the left and the spring contact on the right. In an alternative embodiment, the spring contact on the left and the male on the right.

The battery pack contains a small printed circuit board (PCB) that controls charging aspects of the pack and includes a synchronous boost converter and a microchip for battery management.

In some embodiments, the circuit board has two main components: a) the TSPS61090 which boosts the 3.7 voltage from the batteries to 5 volts and b) the second chip MCP73871T which controls the battery charging logic and the load sharing features. With these two chips the circuit board powers the lock while also charging the batteries, and the boost feature makes sure that the lock is always getting 5 volts, that it needs to operate.

In some embodiments, the battery pack is assembled by:
1) soldering the copper pad of the bottom cover to the PCB (BC−);
2) soldering three more wires onto BC+, and the J4 connections;
3) running the wires through that body of the device; soldering the BC+ wire to the copper pad of the top cover;
4) running the J4 wires through their respective holes in the top cover;
5) closing the battery pack so that top and bottom cover are secure to the body;
6) ensuring alignment of the PCB with hole for the receiver connection;
7) attaching contact pad to the top cover, cut the J4 wires to an appropriate length and solder to their respective contacts;
8)placing battery pack into the device; and
9) taping or shrink wrapping in the batteries into place.

In some embodiments, there is provided a kit for converting the conventional battery powered door lock into an inductively powered door lock. The kit includes the doorframe module, door module, battery pack and instructions. Instructions include installation instructions including placement of the respective modules.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. An inductively powered door lock comprising an electric door lock equipped with a power receiving module operatively associated with one or more rechargeable batteries within the door lock and transmitting module with the door frame.

2. The inductively powered door lock of claim 1, wherein the inductively powered door lock is compatible with the Qi and/or the PMA standards.

3. A kit for converting a powered door lock to an inductively powered door lock, the kit comprising a doorframe module, door module, battery pack and installation instructions.

4. The kit according to claim 3, wherein the doorframe module comprises an enclosure with base station/power transmitter housed within.

5. The kit according to claim 4, wherein the base station/power transmitter comprises a transmitter, a transmitting coil and surface for interfacing with the door module.

6. The kit according to claim 5, wherein the transmitter is a NXQ1TXH5 5V Qi wireless transmitter and the transmitting coil is a Qi-compliant type A5, A11, A12, or A16 transmitter coil.

7. The kit according to claim 3, wherein the door module comprises a receiver unit with secondary coil.

8. The kit according to claim 7, wherein the receiver unit comprises a BQ51013B VQFN package (BQ51013BRHLR) receiver chip.

9. The kit according to claim 3, wherein the battery pack comprises battery holder having a body, top and bottom covers with contacts, circuit board and lithium ion batteries.

10. The kit according to claim 9, wherein the lithium ion batteries are two 14430 lithium-Ion batteries.

11. The kit according to claim 9, wherein the circuit board comprises a synchronous boost converter and a microchip for battery management.
